(19) United States
(12) Patent Application Publication
(10) Pub. No.: US 2018/0361998 A1
(43) Pub. Date: Dec. 20, 2018

(54) VEHICLE CAMERA MODULE WITH INTEGRATED LENS CLEANER

(71) Applicant: MAGNA ELECTRONICS INC., Auburn Hills, MI (US)

(72) Inventor: Ronald R. Renaud, Oxford, MI (US)

(21) Appl. No.: 16/007,220

(22) Filed: Jun. 13, 2018

Related U.S. Application Data
(60) Provisional application No. 62/519,314, filed on Jun. 14, 2017.

(51) Int. Cl. B60S 1/56; B60R 1/00; H04N 5/217; H04N 5/225; G06K 9/00

(52) U.S. Cl. CPC B60S 1/566; B60R 1/00; H04N 5/2171; B60S 1/46; G06K 9/00791; B60R 2300/8066; H04N 5/2257

(57) ABSTRACT

A vision system of a vehicle includes a camera module configured to be disposed at an exterior portion of a vehicle. The camera module includes a mounting base and a camera that is pivotally mounted at the mounting base. The camera includes an imager and a lens. The camera is pivoted relative to the mounting base between a stowed position and a deployed position. The camera module includes a wiping element that is disposed at the mounting base and configured to wipe the lens when the camera is pivoted between the stowed and deployed positions. A portion of the wiping element is disposed at a lens wiping region and configured to wipe the lens when the camera is pivoted between the stowed and deployed positions. Pivoting the camera between the stowed and deployed positions causes presentation of a clean portion of the wiping element to wipe the lens.

### CROSS REFERENCE TO RELATED APPLICATION

The present application claims the filing benefits of U.S. provisional application Ser. No. 62/519,314, filed Jun. 14, 2017, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 7,965,336; 5,949,331; 5,670,935 and/or 5,550,677, which are hereby incorporated herein by reference in their entireties.

Obscuring view by mud, salt or dust is becoming an increasing issue for vehicle cameras as their ability to determine and recognize objects can be limited or interrupted. Vehicle manufacturers have recently started to add washer nozzles mounted at the vehicle in close proximity to the camera lens. Typically, the camera washer is integrated into the existing windshield washer system and is activated through the same pump.

### SUMMARY OF THE INVENTION

The present invention provides a vision system or imaging system or driver assistance system for a vehicle that utilizes one or more cameras (preferably one or more CMOS cameras) to capture image data representative of images exterior of the vehicle, and provides a cleaning or wiping element that wipes or cleans the camera lens as the camera is moved between a stowed position and a use position. The camera may be mounted or disposed at an exterior structure of the vehicle, such as, for example, a vehicle panel, grill, bumper, fascia, light bar, center high mounted stop lamp (CHMSL) or the like, with its lens viewing exterior of the vehicle when the camera is in its use or deployed position.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a vision system that incorporates cameras in accordance with the present invention;

FIG. 2 is a perspective view of the vehicle with the camera shown in its stowed position;

FIG. 3 is a perspective view of the vehicle with the camera shown in its use position;

FIG. 4 is a perspective view of a camera module of the present invention, shown in its stowed position with a built-in wiper engaging the lens or cover of the camera;

FIG. 5 is a perspective view of the camera module of FIG. 4, shown in its use or deployed position;

FIG. 6 is a perspective view of the camera module similar to FIG. 5, shown with a heating element disposed at the lens;

FIG. 7 is a side elevation of another camera module, shown in its stowed position with a washer nozzle for spraying the lens when in its deployed position or when moving between its deployed and stowed positions;

FIG. 8 is another side elevation of the camera module of FIG. 8, shown in its use or deployed position with the washer nozzle spraying the lens; and

FIG. 9 is a side elevation of a flush mount camera module, shown in its stowed position.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a top down or bird's eye or surround view display and may provide a displayed image that is representative of the subject vehicle, and optionally with the displayed image being customized to at least partially correspond to the actual subject vehicle.

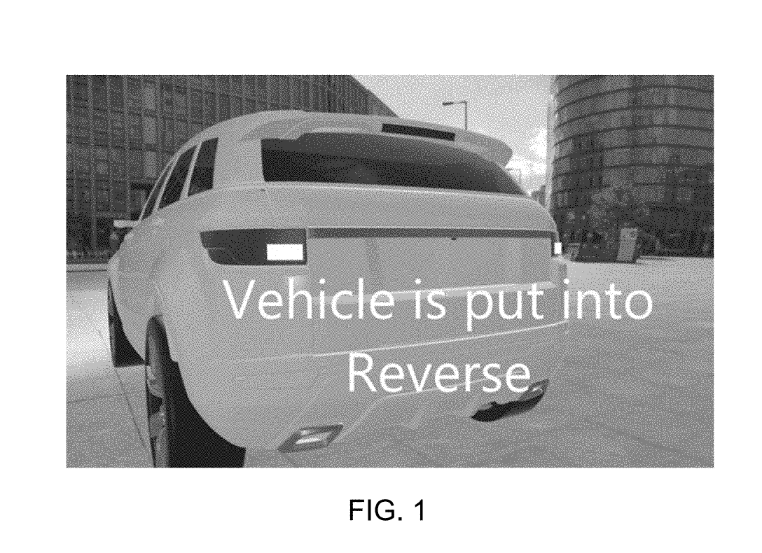

Referring now to the drawings and the illustrative embodiments depicted therein, a vehicle includes an imaging system or vision system that includes at least one exterior facing imaging sensor or camera, such as a rearward facing imaging sensor or camera (and the system may optionally include multiple exterior facing imaging sensors or cameras, such as a forward facing camera at the front (or at the windshield) of the vehicle, and a sideward/rearward facing camera at respective sides of the vehicle), which captures images exterior of the vehicle, with the camera having a lens for focusing images at or onto an imaging array or imaging plane or imager of the camera (FIG. 1). The vision system includes a control or electronic control unit (ECU) or processor that is operable to process image data captured by the cameras and may provide displayed images at a display device for viewing by the driver of the vehicle (the control and/or the display device may be disposed anywhere at or in the vehicle). The data transfer or signal communication from the camera to the ECU may comprise any suitable data or communication link, such as a vehicle network bus or the like of the equipped vehicle.

The cameras each include a housing and imager and a lens that is oriented such that the camera views exterior of the vehicle. Such automotive camera lenses are susceptible to dirt or debris collecting at the lens of the camera. Also, because the camera is disposed at the vehicle exterior, such cameras are exposed to cold temperatures and temperature and humidity fluctuations, whereby moisture and/or ice or snow may form at the lens.

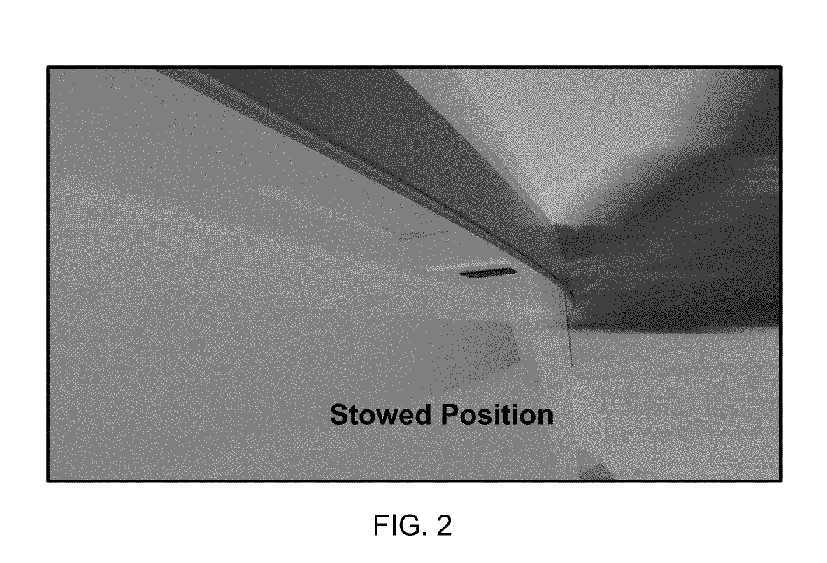

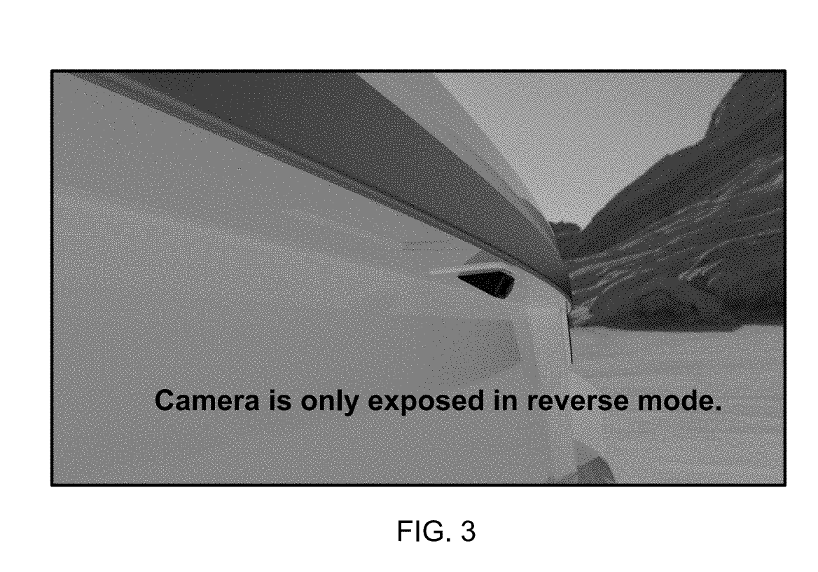

The present invention provides a camera module that is disposed at an exterior portion of the vehicle so as to be hidden when in a stowed position, and so as to be able to be exposed and to view exterior the vehicle when in a use or deployed position. In the illustrated embodiment, the camera module comprises a rearward viewing backup assist camera that is mounted at an underside of an overhanging vehicle body or trim portion, such as at a generally central region at the rear of the vehicle. As can be seen with reference to FIGS. 1-3, when the vehicle is reversing, the camera is pivoted relative to a mounting base from a stowed position (FIG. 2) to a use or deployed position (FIG. 3), where the camera's lens is exterior the vehicle and the camera views exterior and rearward of the vehicle for capturing image data.

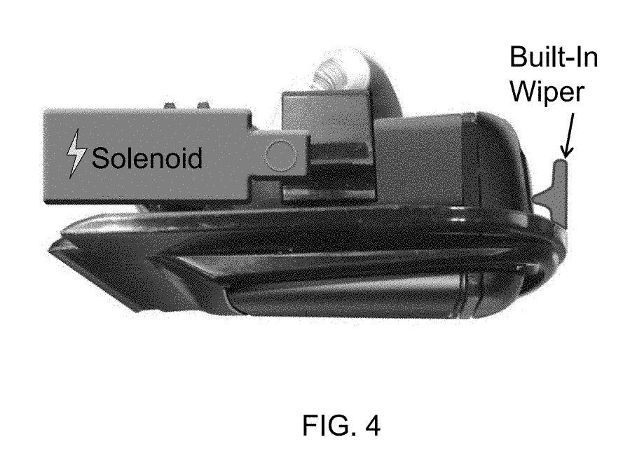

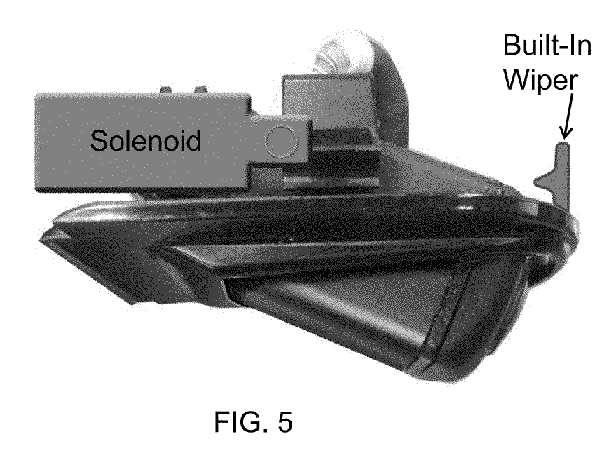

As shown in FIGS. 4 and 5, the camera module comprises a mounting base that mounts or attaches the camera module at the exterior portion of the vehicle, and a camera that is pivotally mounted at the mounting base. When in the stowed position, the camera (and lens) is disposed in an interior cavity of the vehicle body or trim and is not exposed to the exterior environment. When stowed, a lower portion or wall of the camera is disposed along the mounting base so as to close the camera module and limit intrusion of water or debris into the interior cavity of the vehicle body. A sealing element may be disposed at the mounting base and/or the camera body to enhance sealing of the camera module when the camera is in its deployed position.

The camera is pivoted between the use and stowed positions via a solenoid or other type of actuator. For example, the module may use a spring loaded solenoid that retracts the camera into its housing during forward vehicle operation when the solenoid is energized, and that deploys into the operating position by use of the spring when the vehicle is placed into reverse and backing up. As also shown in FIGS. 4 and 5, the camera module includes a built-in wiper that is attached at an interior portion of the mounting base (so as to be interior of the vehicle body or sheet metal or trim) when the camera module is mounted at the vehicle) and is configured to engage the lens or cover of the camera and to wipe over the exterior surface of the lens or cover as the camera is pivoted between its use and stowed positions.

When the camera is in the stowed position, the lens or cover is not exposed and thus is not subject to the dirt or mud or the like flying up and hitting it when the vehicle is traveling forward along the road. When voltage is applied to the solenoid, the camera is moved to and retained in its stowed position. This keeps the camera in its housing and away from debris and dirt. As the camera is moved to the deployed position and is activated, there is a wiping action by the wiper as the camera and lens move toward and into the stowed position.

Optionally, the wiper may comprise a wiping element that is removable and/or replaceable so that a clean wiping element may be provided after many uses (where the wiping element gets worn and dirty). The camera module may include a removable cover at the wiping element so a user can readily access the wiping element to remove the wiping element for cleaning or replacement. The camera module may generate a signal after a threshold number of wipes by the wiping element (such as after 100 wipes or 500 wipes or 1000 wipes or more or less), whereby a display device or indicator in the vehicle may generate an alert or indication to an occupant of the vehicle that indicates when it is time to clean or replace the wiping element.

Optionally, the wiping element may comprise a strip or a disc whereby the strip or disc is episodically indexed after a threshold number of wipes (such as after 20 wipes or 100 wipers or more or less). When indexed, the wiping strip or disc moves or shifts so that a fresh or clean or not-yet-used portion of the wiping strip or disc moves into a location where it wipes the lens when the camera is deployed and undeployed or retracted or stored. For example, a wiping disc may be indexed or rotated after a threshold number of wipes to rotate a used portion of the disc away from the lens wiping area and to rotate a fresh clean portion of the disc to the lens wiping area or location. The disc may be indexed or rotated a particular number of times before the camera module generates a signal so that a display device or indicator in the vehicle generates an alert or indication to an occupant of the vehicle that it is time to clean or replace the wiping element. For example, if the disc wiping portion or region spans about 30 degrees of the disc, the wiping disc may be indexed or rotated twelve times before it has to be replaced or cleaned.

Similarly, if the wiping element is a wiping strip, the strip may be indexed linearly after a threshold number of wipes to move a clean portion of the strip to the lens cleaning area. The wiping strip may be indexed a plurality of times, with the number of times it is indexed depending on the overall length of the strip and how many wiping portions (that span the camera lens for cleaning) are disposed along the wiping strip.

Optionally, the wiping strip or disc may be episodically indexed a small amount each time the camera is deployed (or after only a few deployments of the camera) to provide a clean portion of the strip or disc at part of the cleaning area, so that, over time and over multiple uses, part of the wiping element is always fresh and no part of the wiping element is always in use.

When no voltage is applied to the solenoid, the camera is deployed (rear image viewable) by the spring internal to the solenoid. For the reverse backup assist camera, this is activated by reverse gear input. This is also a safety default action as it does not require voltage, so that the camera is deployed by default if there is a loss of power to the solenoid.

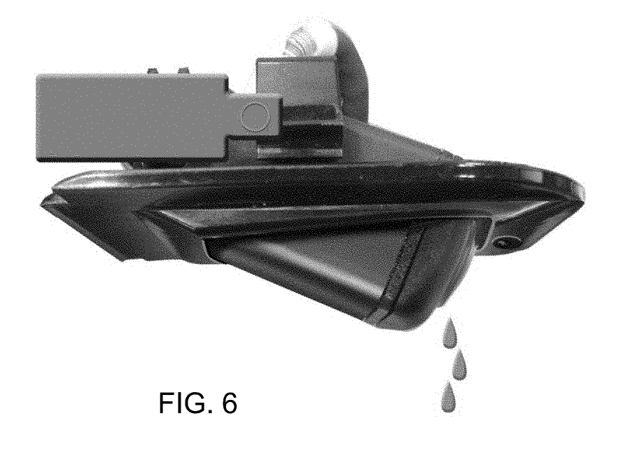

Optionally, and with reference to FIG. 6, the camera module may include a heating element to heat the lens or cover element to melt snow or ice from the lens. The heating element may comprise an electrically heated film or coating that is placed on or in the lens and that heats when powered. The heating element may utilize aspects of the heating elements described in U.S. Publication No. US-2015-0321621, which is hereby incorporated herein by reference in its entirety.

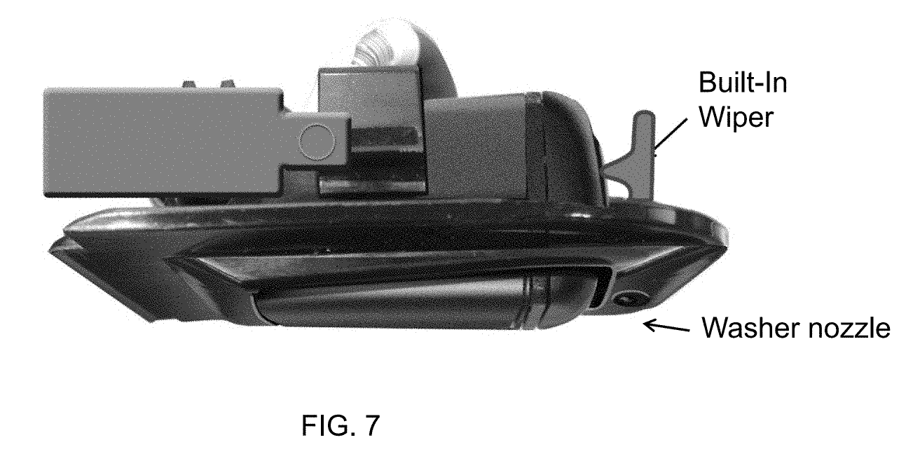

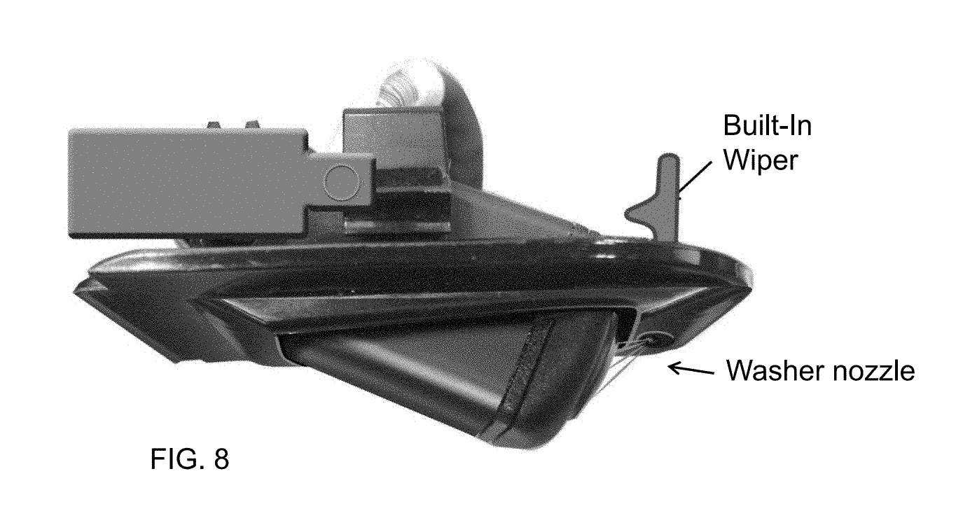

Optionally, and such as shown in FIGS. 7 and 8, the camera module may include a washer nozzle at the mounting base. The washer nozzle may be operable to spray fluid at or onto or across the lens or cover as the camera is deployed or after the camera is deployed, so as to clean the lens or cover. Optionally, the spray may encompass a substantial amount of the lens or cover when the camera is deployed (as shown in FIG. 8), or the spray may spray a line of fluid at a small portion of the lens or cover so as to clean portions of the lens or cover as the camera is moved to its deployed position. Optionally, the nozzle may be directed to spray fluid onto the lens or cover when the camera is in its stowed position, so as to also spray fluid onto the wiper element to clean the wiper element.

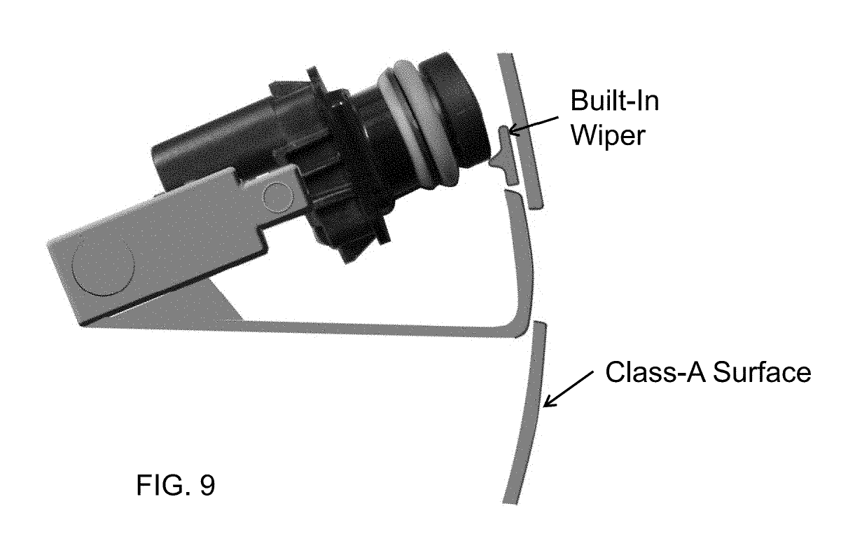

Optionally, and such as shown in FIG. 9, the camera module may comprise a flush mount camera and may be disposed behind an exterior panel or surface or body portion of the vehicle, such that the camera is pivoted relative to its mounting base to move the camera away from an opening or aperture of the vehicle body portion to stow the camera (as shown in FIG. 9) and to move the camera into and aligned with the opening or aperture for use of the camera (with the camera viewing through the aperture when in the use position). The camera module includes a built-in wiper that wipes the lens or cover of the camera as the camera is moved between its stowed and deployed positions.

Thus, the present invention provides a camera cleaner to enhance image capture by the camera, such as a rearward viewing camera. The camera module provides quick motion cleaning and may provide a rapid movement of the camera from its use position to its stowed position and back to its use position, such as responsive to a determination (during use of or operation of the camera) that the lens is partially occluded (such as can be determined via image processing of image data captured by the camera). For example, responsive to detection of occlusion or blockage of the lens during a reversing maneuver of the vehicle (with the camera in its deployed position and capturing image data for use by a rear backup assist display), the actuator or solenoid may rapidly pivot the camera to its stowed position and back to the deployed position to clean the lens. The time to pivot both directions may take less than two seconds, preferably less than one second or less than a half of a second, so that the time in which the camera is not capturing image data during a reversing maneuver is limited or as short as possible. The camera module thus provides a “blink of an eye” type cleaning of the camera lens.

The camera module may be suitable for use at other exterior viewing camera locations. Such all-around viewing cameras may capture image data for various driver assistance systems, such as for autonomous or semi-autonomous driving, advanced cruise control, driver maneuver assistance, blind spot detection, lane departure warning and/or the like. The camera module thus provides a safer and more useful rear view camera system, with the viewing by the camera being always clear.

The camera cleaner system may utilize aspects of the lens washers or cleaners described in U.S. Publication Nos. US-2016-0272163 and/or US-2016-0264064, and/or U.S. patent application Ser. No. 15/874,919, filed Jan. 19, 2018 (Attorney Docket MAG04 P-3242), which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system of a vehicle, said vision system comprising:
a camera module configured to be disposed at an exterior portion of a vehicle, said camera module comprising a mounting base and a camera that is pivotally mounted at said mounting base;
wherein said camera comprises an imager and a lens;
wherein said camera module comprises a solenoid that is powered to pivot said camera relative to said mounting base;
wherein, with said camera module disposed at the exterior portion of the vehicle, and responsive to powering of said solenoid, said camera pivots relative to said mounting base between a stowed position, where said lens is not exposed at an exterior of the vehicle, and a deployed position, where said lens is exposed at the exterior of the vehicle and said camera has a field of view exterior of the vehicle;
wherein said camera module comprises a wiping element that is disposed at said mounting base, with a portion of said wiping element disposed at a lens wiping region and configured to wipe said lens when said camera is pivoted between the stowed and deployed positions; and
wherein pivoting said camera between the stowed and deployed positions episodically causes presentation of a clean portion of said wiping element to wipe said lens.

2. The vision system of claim 1, wherein said wiping element is indexed to position the clean portion of said wiping element at the lens wiping region.

3. The vision system of claim 2, wherein said wiping element is indexed after said camera module pivots between the stowed position and the deployed position a threshold number of pivots.

4. The vision system of claim 3, wherein said wiping element comprises a circular disc, and wherein a portion of said circular disc is disposed at the lens wiping region, and wherein said circular disc is rotated after said camera module pivots between the stowed position and the deployed position the threshold number of pivots.

5. The vision system of claim 3, wherein said wiping element comprises a strip, and wherein a portion of said strip is disposed at the lens wiping region, and wherein said strip is linearly indexed after said camera module pivots between the stowed position and the deployed position the threshold number of pivots.

6. The vision system of claim 3, wherein said wiping element is removable and wherein, after said wiping element is indexed a threshold number of times, an indication is generated so a user can remove said wiping element for cleaning or replacement.

7. The vision system of claim 1, wherein said camera module comprises a rear camera module for backup assist, and wherein said solenoid pivots said camera to the deployed position responsive the vehicle being shifted into a reverse gear.

8. The vision system of claim 7, wherein said solenoid is powered when the vehicle is not in reverse gear and is not powered when the vehicle is in reverse gear.

9. The vision system of claim 1, wherein said solenoid is operable to pivot said camera from the deployed position, to the stowed position and back to the deployed position responsive to a determination, via image processing of image data captured by said camera, that said lens is at least partially occluded.

10. The vision system of claim 1, wherein said wiping element is not exposed to the exterior environment.

11. The vision system of claim 1, comprising a washer at said mounting base, and wherein said washer episodically sprays fluid onto said lens of said camera.

12. The vision system of claim 11, wherein said washer is configured to episodically spray fluid onto said wiping element.

13. The vision system of claim 1, wherein said camera module comprises a heating element disposed at said lens and operable to heat said lens.

14. A vision system of a vehicle, said vision system comprising:
a camera module configured to be disposed at an exterior portion of a vehicle, said camera module comprising a mounting base and a camera that is pivotally mounted at said mounting base;
wherein said camera comprises an imager and a lens;
wherein said camera module comprises an actuator that is powered to pivot said camera relative to said mounting base;
wherein, with said camera module disposed at the exterior portion of the vehicle, and responsive to powering of said actuator, said camera pivots relative to said mounting base between a stowed position, where said lens is not exposed at an exterior of the vehicle, and a deployed position, where said lens is exposed at the exterior of the vehicle and said camera has a field of view exterior of the vehicle;
wherein said camera module comprises a wiping element that is disposed at said mounting base, with a portion of said wiping element disposed at a lens wiping region and configured to wipe said lens when said camera is pivoted between the stowed and deployed positions;
wherein said wiping element is not exposed to the environment exterior the vehicle;
wherein said wiping element is indexed to position a clean portion of said wiping element at the lens wiping region after a threshold number of pivots of said camera between the stowed position and the deployed position; and
wherein said wiping element is removable and wherein, after said wiping element is indexed a threshold number of times, an indication is generated so a user can remove said wiping element for cleaning or replacement.

15. The vision system of claim 14, wherein said wiping element comprises a circular disc, and wherein a portion of said circular disc is disposed at the lens wiping region, and wherein said circular disc is rotated after said camera module pivots between the stowed position and the deployed position the threshold number of pivots.

16. The vision system of claim 14, wherein said wiping element comprises a strip, and wherein a portion of said strip is disposed at the lens wiping region, and wherein said strip is linearly indexed after said camera module pivots between the stowed position and the deployed position the threshold number of pivots.

17. The vision system of claim 14, wherein said actuator is operable to episodically pivot said camera from the deployed position to the stowed position and back to the deployed position responsive to a determination, via image processing of image data captured by said camera, that said lens is at least partially occluded.

18. A vision system of a vehicle, said vision system comprising:
a camera module configured to be disposed at an exterior portion of a vehicle, said camera module comprising a mounting base and a camera that is pivotally mounted at said mounting base;
wherein said camera comprises an imager and a lens;
wherein said camera module comprises an actuator that is powered to pivot said camera relative to said mounting base;
wherein, with said camera module disposed at the exterior portion of the vehicle, and responsive to powering of said actuator, said camera pivots relative to said mounting base between a stowed position, where said lens is not exposed at an exterior of the vehicle, and a deployed position, where said lens is exposed at the exterior of the vehicle and said camera has a field of view exterior of the vehicle;
wherein said camera module comprises a wiping element that is disposed at said mounting base, with a portion of said wiping element disposed at a lens wiping region and configured to wipe said lens when said camera is pivoted between the stowed and deployed positions;
wherein said wiping element is not exposed to the exterior environment;
wherein said camera module comprises a washer at said mounting base, and wherein said washer episodically sprays fluid onto said lens of said camera, and wherein said washer episodically sprays fluid onto said wiping element;
wherein pivoting said camera between the stowed and deployed positions causes said wiping element to be indexed to position a clean portion of said wiping element at the lens wiping region, and wherein said wiping element is indexed after said camera module pivots between the stowed position and the deployed position a threshold number of pivots; and
wherein said wiping element is removable and wherein, after said wiping element is indexed a threshold number of times, an indication is generated so a user can remove said wiping element for cleaning or replacement.

19. The vision system of claim 18, wherein said wiping element comprises a circular disc, and wherein a portion of said circular disc is disposed at the lens wiping region, and wherein said circular disc is rotated after said camera module pivots between the stowed position and the deployed position the threshold number of pivots.

20. The vision system of claim 18, wherein said wiping element comprises a strip, and wherein a portion of said strip is disposed at the lens wiping region, and wherein said strip is linearly indexed after said camera module pivots between the stowed position and the deployed position the threshold number of pivots.
